(19) United States
(12) Patent Application Publication
(10) Pub. No.: US 2003/0008164 A1
(43) Pub. Date: Jan. 9, 2003

(54) Composite plate

(76) Inventor: Wilhelm Klepsch, Kaprun (AT)

Correspondence Address: JEFFREY D. WASHVILLE, LORUSSO & LOUD, 440 COMMERICAL STREET, BOSTON, MA, 02109, US

(21) Appl. No.: 10/178,669

(22) Filed: Jun. 21, 2002

Related U.S. Application Data
(63) Continuation of application No. 08/793,590, filed on May 19, 1997, now abandoned.

(30) Foreign Application Priority Data
Sep. 6, 1994 (AT) A1704/94

(51) Int. Cl. B32B 27/08

(52) U.S. Cl. 428/520; 428/522

(57) ABSTRACT

This invention concerns a composite plate from which an insert for sanitary articles, in particular bath tubs, shower bases, flush bowls and wash basins can be produced by deep drawing, wherein a coating of polymethyl methacrylate (PMMA, acrylic glass) is arranged on a support in particular of acrylonitrile-butadiene-styrene (ABS).

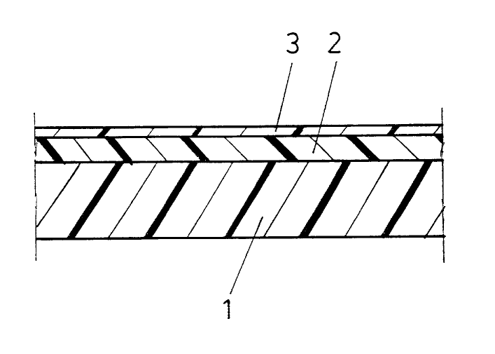

The invention concerns a composite plate from which an insert for sanitary articles, in particular bath tubs, shower bases, flush bowls and wash basins can be produced by deep drawing, wherein a coating of polymethyl methacrylate (PMMA, acrylic glass) is arranged on a support in particular of acrylonitrile-butadiene-styrene (ABS).

At the present time plastic plates comprising moulded acrylonitrile or co-extrusion plates of ABS/PNM are used for various inserts for sanitary articles (bath tubs, flush bowls, shower bases and shower panels).

The European standard EN 263 precisely describes the requirements and testing methods that a plate of moulded acryl for bath tubs and shower bases must fulfil for domestic use.

The requirements prescribed in EN 263 (besides the general requirements in terms of the moulded acryl plate in relation to the raw material used) were hitherto only partially met by co-extruded plates of ABS with a coating of polymethyl methacrylate (PMMA).

Hitherto the co-extruded ABS/PMMA-plates were not capable with 100% certainty of complying with the requirement set forth in section 9 of the standard EN 263 ‘Resistance to hot water’. Added to this was the experience that the prescribed test is not sufficiently close to reality insofar as it does not take account of the influence of the aggressive solvents, which in many countries are permitted as a constituent of cleaning agents, on the resistance of plastic materials to hot water. Therefore, in the development of co-extruded ABS/PMMA-plates for sanitary articles, the applicants developed their own test which, in regard to testing of the co-extruded plates in accordance with the procedure of section 9 of the standard EN 263, additionally provides for a cleaning operation with commercially available aggressive cleaning agents, between the individual cycles.

The present invention is based on the realisation that this test can only be passed when there is a sufficiently high level of chemical resistance and hot/cold water resistance in the case of the coating of polymethyl methacrylate.

It is further known that these requirements can be better met by the PMMA-covering layer if the molecular weight of the raw material used is as high as possible or if the melt flow index (MFI) is as low as possible. The present applicants' EP-B1-225 500 describes composite plates of ABS and a coating of P for the production of deep-drawn bath tub inserts, which are co-extruded through a wide-slot nozzle and are characterised in that the acrylic glass forming the coating has a melt flow index MFI 230 C/3.8 (in accordance with German standard DIN 53735) of at most 2 g/10′. It has been found that this is not sufficient in all cases to pass the above-indicated test.

Furthermore EP-B1-304 679 describes a possible way of improving the hot-cold water resistance and the resistance to stress cracking in regard to composite plates of ABS and PMMA, wherein arranged on a support of ABS is a coating of PMMA provided with an additional covering layer which comprises 30 to 70 percent by weight of PVDF (polyvinylidene fluoride) and the balance PMMA. With those plates, it was already possible substantially to comply with the requirements listed in EN 263 in respect of moulded acrylic plates for bath tubs and shower bases for domestic use.

The stress crack resistance to alcohols, more especially methanol, and in the test in accordance with section 9 of the standard EN 263, with an additional cleaning operation, was however adjudged to be still not adequate.

The object of the present invention is to provide a composite plate of the general kind set forth in the opening part of this specification, which is distinguished by an improved level of hot-cold water resistance as well as stress crack resistance to chemicals contained in cleaning agents, in particular alcohol. In accordance with the invention this is achieved in that the coating of acrylic glass comprises a mixture of impact toughness-modified PMMA and standard PMMA. The term standard PMMA is used to denote homo-polymethyl methacrylates. The term impact toughness-modified PMMA is used to denote in particular copolymers (alloys) of methyl methacrylate with less than 30% (percent by mass), preferably less than 10%, of other acrylates (in particular butyl acrylate, ethyl acrylate or methyl acrylate).

It has been found from the applicants' investigations that the level of stress crack resistance, in particular in relation to alcohols, in the case of PMMA, is improved, the lower the modulus of elasticity (E-modulus) is and the lower the MFT (melt flow index) is. In the general case this object can be very satisfactorily attained by impact toughness-modified high-molecular types of HMM. (low flow melt indices generally below 2.0 g/10′ at 230° C./3.8 in accordance with German standard DIN 53753).

The disadvantage of these impact toughness-modified types of PMMA however is that they have a level of scratch resistance which is low in comparison with non-impact toughness-modified P and in the event of hot water storage for a prolonged period of time, a clouding effect or ‘haze’ occurs in the PMMA layer. For that reason, it was hitherto not possible to use high-molecular impact toughness-modified types of PMMA in co-extrusion plates of ABS with PMMA, for the subsequent production of bath tub and shower base inserts.

Now, the basic idea of the invention is that of arriving at a substantial improvement in the hot-cold water resistance and chemical stress crack resistance with at the same time undiminished scratch resistance, by specific deliberate mixing of high-molecular PMMA (low MFI) with high-molecular impact toughness-modified PMMA as a covering layer in the case of composite plates with a coating of PMMA.

While a mixture of impact toughness-modified PMMA with standard PMMA can fundamentally improve the desired properties, investigations carried out by the applicants in relation to mixtures have shown that only a relatively small range of the possible mixtures satisfies highest requirements (in particular the standard EN 263 with additional cleaning by aggressive, commercially available cleaning agents), in regard to hot-cold water resistance and chemical stress crack resistance. That small range is best described by the melt flow index and/or the modulus of elasticity of the mixtures of impact toughness-modified PMMA with standard PMMA, namely MFI below 0.8 and modulus of elasticity between 2500 and 2800 MPa.

On the basis of the present results, very high hot-cold water resistance and stress crack resistance (in particular in relation to alcohols) are achieved by mixtures of impact toughness-modified PMMA with standard PMMA, which have an MFI 230° C./3.8 in accordance with German standard DIN 53753 of at most 0.8 and at the same time a modulus of elasticity (in accordance with ISO 527) of 2500 to 2800 MPa.

A composite plate according to the invention may for example comprise a supporting plate 1 which is several millimeters in thickness and which comprises ABS possibly mixed with PMMA. The next layer as indicated at 2 is a layer of ABS which is about 10-20% in thickness (relative to the overall thickness) and which forms the coloured support for a coating 3 of acrylic glass (PMMA) of a thickness of 1-30% (with respect to the overall thickness). The composite plate can be produced for example by co-extrusion of the layers in a wide-slot nozzle.

1. A composite plate from which an insert for sanitary articles (bath tubs, shower bases, flush bowls and wash basins) can be produced by deep drawing, wherein a coating (3) of polymethyl methacrylate (PMMA, acrylic glass) is arranged on a support in particular of acrylonitrile-butadiene-styrene (ABS), characterised in that the coating of acrylic glass comprises a mixture of impact toughness-modified PMMA and standard PMMA.

2. A composite plate according to claim 1 characterised in that the MFI of the mixture 230° C./3.8 in accordance with German standard DIN 53735 is below 0.8 g/10′.

3. A composite plate according to claim 1 and claim 2 characterised in that the modulus of elasticity of the mixture used in the coating (3) is from 2500 to 2800 MPa.

4. A composite plate according to one of claims 1 to 3 characterised in that the impact toughness-modified PMMA is a copolymer of methyl methacrylate and less than 30% (percent by mass) and preferably less than 10% is acrylate.

5. A composite plate according to claim 4 characterised in that butyl acrylate, ethyl acrylate or methyl acrylate is used as the acrylate.
